(19) United States
(12) Patent Application Publication
(10) Pub. No.: US 2024/0303119 A1
(43) Pub. Date: Sep. 12, 2024

(54) AUTOMATED PROCEDURE GENERATION AND RECOMMENDATION

(71) Applicant: INTERNATIONAL BUSINESS MACHINES CORPORATION, Armonk, NY (US)

(72) Inventors: Xiao Xuan Fu, Wuhan (CN); Jiang Yi Liu, Beijing (CN); Wen Qi WQ Ye, Beijing (CN); Si Yu Chen, Beijing (CN); Min Cheng, Beijing (CN)

(21) Appl. No.: 18/180,793

(22) Filed: Mar. 8, 2023

(51) Int. Cl. G06F 9/50; G06N 5/022

(52) U.S. Cl. CPC G06F 9/5027; G06N 5/022

(57) ABSTRACT

Automatic process generation and recommendation can include extracting, in real time, features from user input to a computer. The features extracted can be compared with recorded features corresponding to a prior behavior. A user-intended action can be predicted in response to a match between the features extracted and the features corresponding to the prior behavior. A sequence of processor-executable actions corresponding to the prior behavior can be generated.

### BACKGROUND

This disclosure relates processor-executable procedures, and, more particularly, to automatic generation and execution of processor-executable procedures generated based on predicting user behavior.

A computer user at times encounters a situation in which completion of a particular task requires repeatedly inputting the same sequence of computer instructions. For example, in preparing a report, a user may wish to insert multiple different images. The user may select an image, copy the image from one source, paste the image into the report document, perform some formatting, and perhaps one or more other steps. Depending on the number of different images, the user may need to repeat the same steps multiple times. Many other tasks may similarly require a computer user to perform the same steps multiple times. Such repetition is not only tedious but can also be highly labor-intensive and time consuming. Although a user can write a script or program to replicate certain procedures, doing so can also be labor-intensive and time consuming.

### SUMMARY

In one or more embodiments, a method includes extracting, in real time, features from user input to a computer. The method includes comparing the features extracted with recorded features corresponding to a prior behavior. The method includes predicting a user-intended action in response to a match between the features extracted and the features corresponding to the prior behavior. The method includes generating a sequence of processor-executable actions corresponding to the prior behavior.

In one aspect, the method can include outputting a recommendation that the user enable automatic execution of the sequence of processor-executable actions and executing the sequence of processor-executable actions in response to the user enabling the automatic execution.

In another aspect, the method can include enabling a user to modify the sequence of processor-executable actions based on a user response to the recommendation prior to the executing.

In another aspect, predicting the user-intended action can be performed in response to determining that the prior behavior was executed within a user-specified relevant time interval.

In another aspect, the prior behavior can correspond to an execution stack configured to arrange the sequence of processor-executable actions corresponding to the prior behavior in a time-ordered sequence. Each entity acted upon by the sequence of processor-executable actions corresponding to the prior behavior can be represented by an entity stack configured to arrange state changes of an entity in a time-ordered sequence.

In another aspect, the method can include predicting one or more entities the user intends to be acted upon by the sequence of processor-executable actions.

In another aspect, the method can include generating a new behavior in response to determining that the features extracted do not match features corresponding to the prior behavior. The new behavior can include the features extracted and one or more follow-on features executed in response to additional user input.

In one or more embodiments, a system includes one or more processors configured to initiate executable operations as described within this disclosure.

In one or more embodiments, a computer program product includes one or more computer-readable storage media and program instructions collectively stored on the one or more computer-readable storage media. The program instructions are executable by a processor to cause the processor to initiate operations as described within this disclosure.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 illustrates an example of a computing environment that is capable of implementing an automated procedure generation and recommendation (APGR) framework.

FIG. 2 illustrates an example architecture for the executable APGR framework of FIG. 1.

FIG. 3 illustrates an example method of operation of the APGR framework of FIGS. 1 and 2.

FIG. 4 illustrates an example multilayer network implemented by the APGR framework of FIGS. 1 and 2.

FIG. 5 is an example sequence diagram illustrating certain actions performed by the multilayer network of FIG. 4.

FIGS. 6A-6D illustrate certain operative aspects of the multilayer network of FIG. 4.

FIGS. 7A-7E illustrates an example application of the APGR framework of FIGS. 1 and 2.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to processor-executable procedures, and, more particularly, to automatic generation and execution of processor-executable procedures generated based on predicting user behavior. In accordance with the inventive arrangements described herein, methods, systems, and computer program products are provided that are capable of predicting a user's intended actions based on a prior behavior and generating automatically a sequence of processor-executable actions that replicate the prior behavior. As defined herein, “behavior” means a set of processor-executable actions executed in response to user input. A behavior can include one or more entities (computer-processable data) acted upon by one or more of the processor-executable actions. The sequence of processor-executable actions can replicate previous behavior initiated by the user with respect to the same or similar entities. The inventive arrangements are capable identifying the user's intended actions on the fly in real time. Likewise, the actions replicating a prior behavior can be generated automatically on the fly in real time.

“Action,” as used herein, is an action performed by a processor of a computer in response to a user input. The input, for example, can be an executable instruction. As used herein, “entity” means an identifiable set of data. The entity, for example, can an image, a document, a data file, an audio or video file, or any other type of data that can be processed by a computer. Entities to which replicated actions are applied can also be predicted based on the prior behavior.

In one aspect, the inventive arrangements implement a multilayer model. The multilayer model can be a machine learning model. For example, in certain embodiments the multilayer model is a deep learning neural network. One or more layers of the multilayer model can include a kernel that implements a function, such as an activation function. The kernel generates an output that indicates a probability or likelihood that a user intends to replicate one or more actions in accordance with a prior behavior.

User behavior corresponds to processor-executed actions initiated in response to user input to a computer and to the model. The actions, in certain arrangements, are stored in an execution stack configured to arrange the actions in a time-ordered sequence. Action on an entity can change the state of the entity. In certain arrangements, an entity stack is created for each entity acted on. The entity stack arranges the changes in the entity's state in a time-ordered sequence. The entity stack also records which action or actions change the entity's state, or how that state is being changed. Entities' changes of state, as recorded by the entity stack, are part of the overall pattern of a behavior.

In another aspect, the inventive arrangements can determine a likely behavior of the user from features extracted from user input. The features can include one or more computer instructions to initiate processor-executable actions. The features can also include one or more entities to be acted on or processed in accordance with a processor-executable action. Features extracted from user input can comprise just one or a few features corresponding to a lengthier computer procedure corresponding to a prior behavior. The extracted features are input to the model, which based on the input determines a likely behavior, that is, a user's intent to replicate the actions corresponding to the prior behavior. If the model matches the features extracted to a subset of features corresponding to a prior behavior, the model predicts that the user intends the use input to be followed by the remaining actions corresponding to the prior behavior and automatically generates the actions for the user.

In certain arrangements, the inventive arrangements generate a recommendation to the user to enable the generation of the remaining user-intended actions. If the user follows the recommendation and enables the automatic execution, the predicted user-intended actions are executed automatically without any further input of the user. The user, in some arrangements, can specify one or more entities to be acted on. In other arrangements, the entities to be acted on can be predicted based on the user's behavior. For example, an entity that comprises the same type and/or source of data processed in accordance with the prior behavior but still containing yet-to-be processed data is likely an entity intended by the user to be acted on in accordance with the matching behavior. A directory or file, for example, can be automatically updated to change certain portions (e.g., time, date) while leaving other portions unaffected. The automatically generated recommendation can also enable the user to modify a sequence of processor-executable actions corresponding to a prior behavior.

Further aspects of the inventive arrangements are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

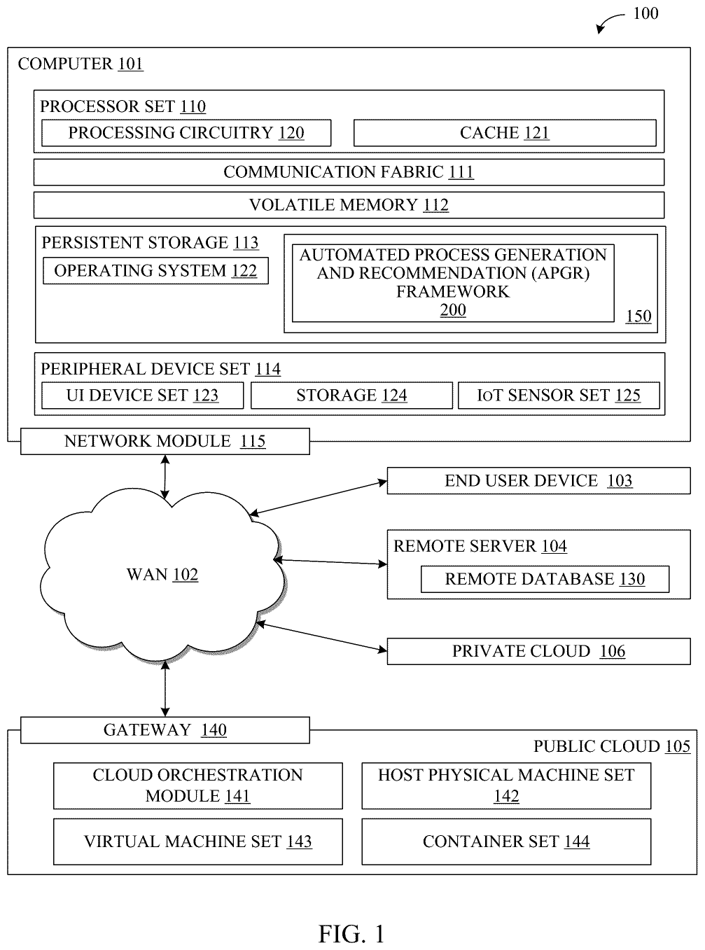

Referring to FIG. 1, computing environment 100 contains an example of an environment for the execution of at least some of the computer code in block 150 involved in performing the inventive methods, such as automated procedure generation and recommendation (APGR) framework 200 implemented as executable program code or instructions. APGR framework 200 is capable of predicting a user's behavior based on features extracted from user input. If the features extracted match those of a prior behavior, APGR framework 200 can respond by generating a sequence of processor-executable actions corresponding to the prior behavior. The sequence of processor-executable actions replicates actions corresponding to the prior behavior. The APGR framework 200 can recommend that the user enable execution of the replicated actions to spare the user having to enter additional user input to a computer to complete a task the user intends to perform in accordance with the prior behavior.

Computing environment 100 additionally includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and APGR framework 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (e.g., a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (e.g., private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

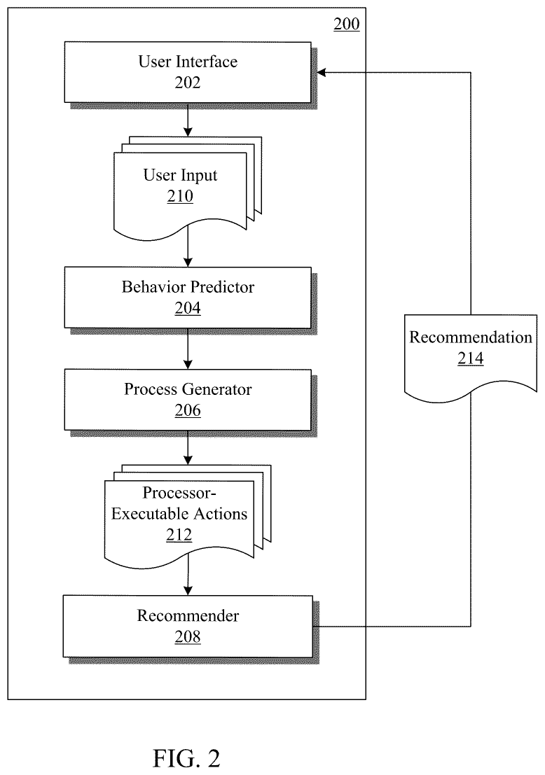

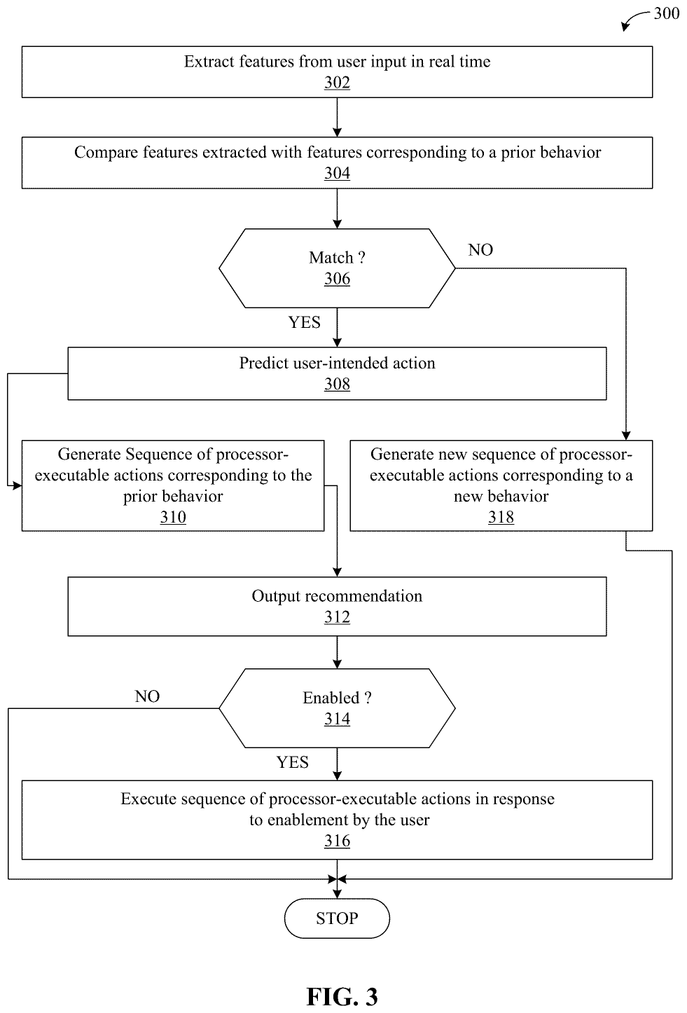

FIG. 2 illustrates an example architecture for the executable APGR framework 200 of FIG. 1. In the example of FIG. 2, APGR framework 200 includes user interface 202, behavior predictor 204, process generator 206, and recommender 208. FIG. 3 illustrates an example method 300 of operation of the APGR framework 200 of FIGS. 1 and 2.

Referring collectively to FIGS. 2 and 3, in block 302, features are extracted by behavior predictor 204 from user input 210 that is received via user interface 202. The features may be extracted by behavior predictor 204 in real time. The features include one or more computer language instructions for initiating one or more processor-executable actions 212. The features can also indicate one or more entities acted upon by processor-executable actions 212. The entities can include individual objects (e.g., image, document), files (e.g., data files, audio files, video files), and other types of data processable by a computer.

In block 304, behavior predictor 204 compares the features extracted with features corresponding to one or more prior behaviors. Each prior behavior comprises a sequence of processor-executable actions. Each prior behavior can also correspond to one or more entities acted upon the sequence of processor-executable actions comprising the behavior.

Behavior predictor 204 is capable of predicting a user intention by comparing the features extracted with features of prior behaviors, that is, with processor-executed actions corresponding to each prior behavior and, in certain instances, one or more entities acted on by the corresponding actions. The extracted features, as described below, need only correspond to a limited subset of a larger set of features (e.g., computer language commands) corresponding to a prior behavior.

In block 306, behavior predictor 204 determines whether features extracted from user input 210 match one or more features of a prior behavior. A match need not be identical. The more similar the features extracted are to one or more features corresponding to a prior behavior, the more likely the user intends to replicate processor-executable actions 212 corresponding to the prior behavior. In certain arrangements, the user can specify a tolerance limit or confidence level for determining a likelihood or probability that features extracted from user input 210 match one or more features of a prior behavior. Feature similarity can be based on the number of features corresponding to a behavior that match features extracted from user input 210 and/or the degree to which an individual feature (e.g., computer language instruction) of the behavior matches or is sufficiently similar to an extracted feature.

In block 308, behavior predictor 204 predicts a user-intended action in response to determining a match in block 306. The prediction is that, in addition to the features matching the extracted features, the user intends to implement all or some of the remaining features (e.g., processor-executable actions) corresponding to the prior behavior identified based on the matching in block 306. In one aspect, the user can specify a relevant time interval for a prior behavior to be deemed a match. In accordance with the user-specified relevant time interval a prior behavior is identified only if the prior behavior was executed with the relevant time interval prior to the user inputting user input 210.

In block 310, process generator 206 generates a sequence of processor-executable actions corresponding to the prior behavior identified based on the matching in block 306. Processor-executable actions 212 can be ones that act upon some or all the same entities corresponding to the prior behavior and/or entities similar to ones corresponding to the prior behavior. In certain embodiments, described below, the user can specify one or more entities to be acted upon if the actions corresponding to the prior behavior are executed.

Optionally, in block 312, recommender 208 outputs recommendation 214 in response to predicting a user-intended action at block 308. Recommendation 214, in certain arrangements, is conveyed to the user via user interface 202 and recommends that the user enable execution of the sequence of processor-executable actions corresponding to the prior behavior. In response to user enablement in block 314, recommender 208 invokes, in block 316, execution of processor-executable actions 212 corresponding to the prior behavior.

In some embodiments, recommendation 214 can be displayed via a graphical user interface, for example, on a command line or in a dropdown window on a computer screen. In certain embodiments, recommendation 214 can also display a list of the computer language instructions to initiate processor-executable actions 212. Recommender 208, in certain embodiments, can invite the user to modify one or more of the computer language instructions thus modifying execution of processor-executable actions 212. In certain embodiments, recommender 208 also can determine from user input specifying one or more entities which entities the user intents processor-executable actions 212 to act upon.

Optionally, APGR framework 200, in block 318, can create a new sequence of processor-executable actions corresponding to a new behavior in response to failing to find, in block 306, a prior behavior having at least some features matching features extracted from user input 210. In that event, APGR framework 200 can monitor user-entered computer language instructions that are input to a computer subsequent to user input 210. If the subsequent user inputs logically relate to features extracted from user input 210, then APGR framework 200 records and compiles the subsequent inputs to generate the new sequence of processor-executable actions corresponding the new behavior. In a later session, features extracted from a user input can be compared to those corresponding to prior behaviors, which now includes the newly created behavior.

In certain embodiments, behavior predictor 204 implements a machine learning or other model, such as a deep learning neural network or other multilayer network.

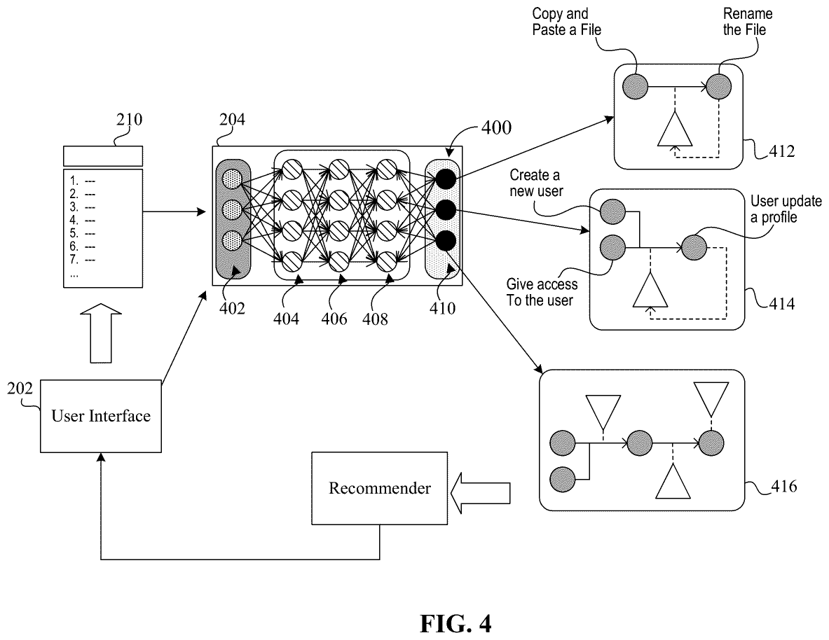

FIG. 4 illustrates an example multilayer network 400 implemented by behavior predictor 204. In addition to input layer 402 and output layer 410, multilayer network 400 illustratively includes three hidden layers, namely feature extraction layer 404, pattern recognition layer 406, and behavior check layer 408. Input layer 402 is connected to feature extraction layer 404. Feature extraction layer 404 is connected to pattern recognition layer 406. Pattern recognition layer 406 is connected to behavior check layer 408. Behavior check layer 408 is connected to output layer 410. Behaviors identified at output layer 410 illustratively correspond to distinct sequences 412, 414, and 416 comprising processor-executable actions and entities acted upon. Depending on a user intent predicted by multilayer network 400 in response to user input 210, recommender 208 recommends via user interface 202 that a user enable the execution of one of sequences 412, 414, or 416.

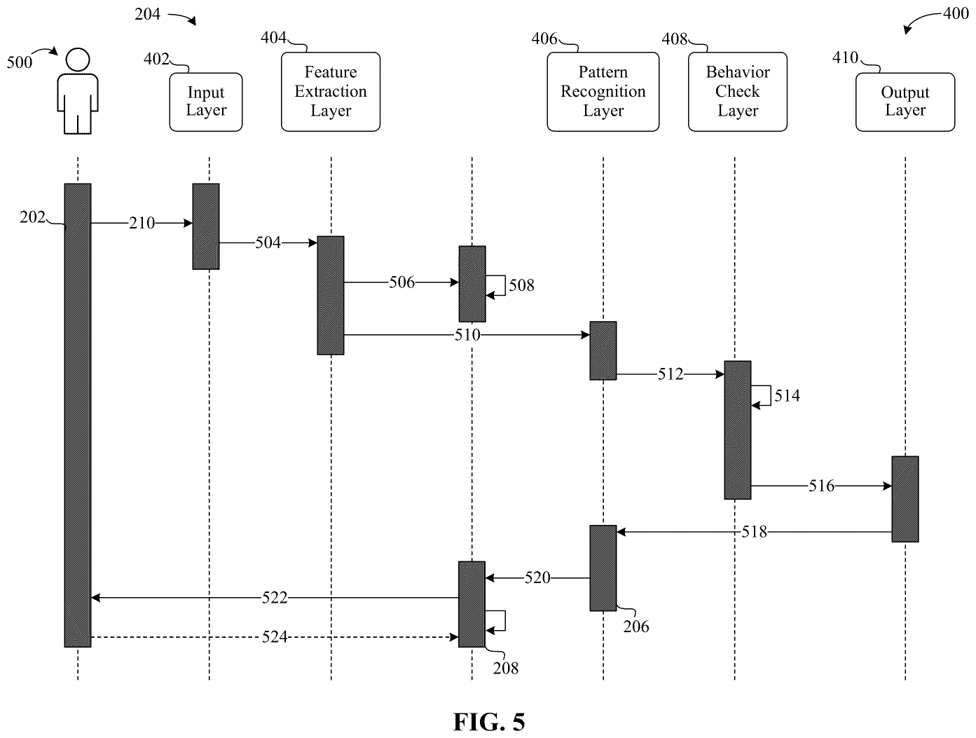

FIG. 5 is an example sequence diagram illustrating certain actions performed by the multilayer network 400. User 500 inputs user input 210 via user interface 202. Input layer 402, as described below, validates user input 210 and conveys validated input at 504 to extraction layer 404. One or more computer language commands are passed at 506 to, and are executed at 508 by, the computer. Meanwhile, extraction layer 404 at 510 extracts features from user input 210 and conveys the features extracted to pattern recognition layer 406. Pattern recognition layer 406 forms the features into an identifiable pattern at 512. The pattern is compared at 514 by behavior check layer 408 to patterns corresponding to one or more prior behaviors to determine whether the pattern created at 512 matches one corresponding to a prior behavior. If not, user-entered computer language commands subsequent to computer language command executed at 506 are monitored by APGR framework 200 and, if logically related, are used by APGR framework 200 to create a new behavior. If the pattern generated at 512 does match one corresponding to a prior behavior, a user intent is predicted at 514 by behavior check layer 408. At 516 the identified behavior is output to output layer 410. The behavior identified is passed at 518 to process generator 206. At 520 a replica of the processor-executable actions corresponding to the identified behavior is passed from process generator 206 to recommender 208. Recommender 208 at 522 recommends execution of the executable actions. In response to user 500's reply at 524, recommender 208 either sends a command to the computer to initiate execution of the executable actions or refrains from further action.

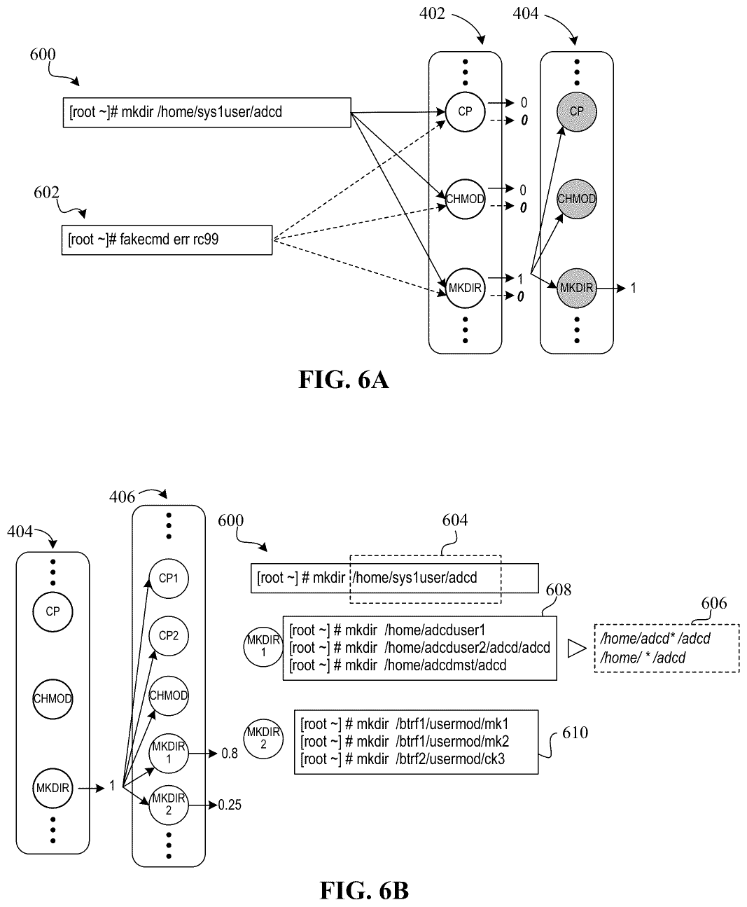

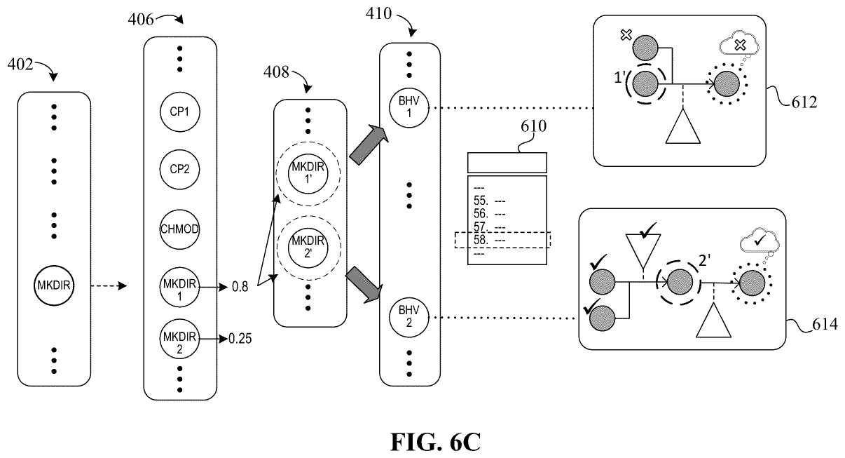

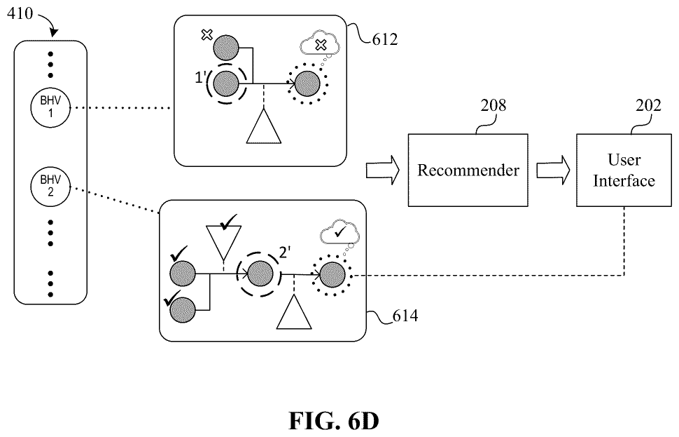

FIGS. 6A-6C illustrate certain operative aspects of the separate layers of multilayer network 400. FIG. 6A illustrates operation of input layer 402. In certain embodiments, input layer 402 is configured to validate user input, which as noted can include computer language instructions (e.g., Linux commands) and possibly one or more entities (e.g., images, documents, files). Input layer 402, accordingly, is capable of eliminating inputs that include faulty syntax, erroneous operands, and other invalid computer instructions. Each node of input layer 402 can include a kernel that implements a function. Each kernel is capable of generating a value (e.g., zero or one) indicating whether an input is valid. Illustratively, user input 600 is a valid computer language instruction. The kernel of node MKDIR outputs a one indicating that input 600 is valid and corresponds to that node (make directory command). The other nodes output a zero indicating that the user input does not correspond to either CP (copy command) or CHMOD (change access mode command). Each function of each of the nodes outputs a zero corresponding to user input 602 in response to identifying fakecmd err rc99 as an invalid input. As illustrated in this example, input layer 402 has one node per different command rather than different permutations of the same command, that is, different functions and/or opcodes rather than different parameters or arguments for a same function and/or opcode. In other embodiments, however, different nodes can correspond to different permutations of the same command.

FIG. 6B illustrates operation of feature extraction layer 404 and pattern recognition layer 406 in response to output of input layer 402. Illustratively, each node of feature extraction layer 404 likewise includes a kernel. Illustratively, the kernel of node MKDIR of feature extraction layer 404 outputs a one in response to command 600 and extracts corresponding features 604 from command 600, which are passed to pattern recognition layer 406. Pattern recognition layer 406, as illustrated in FIG. 6B, generates pattern 606 from extracted features 606. Pattern 606 is more similar to a pattern of features corresponding to MKDIR1 than those of MKDIR2. Accordingly, the kernel of node MKDIR1 outputs a 0.8 versus the 0.25 output by the function of node MKDIR2, indicating a much greater likelihood of similarity between user input 600 and MKDIR1. The kernel yields a value between zero and one. The value is the probability that data processed at one layer is part of a behavior. A probability threshold can be predetermined. For example, the threshold can be 0.5. With a 0.5 threshold, a node in a layer passes data to the next layer only if it determines that there is at least a fifty percent probability that the data is part of the behavior. The probabilities thus aid in determining which data is passed from one layer to another.

For example, extraction layer 404 is capable of parsing the received input and detecting particular instructions included therein as well as arguments for the instructions. In the example, the instruction mkdir is detected as an instruction by node MKDIR, and the path is identified as an argument of that instruction. Though only the path is indicated as a feature, both the instruction and the identified argument may be considered features with each annotated as an instruction or a particular argument and/or argument type expected for that instruction.

Pattern recognition layer 406 is capable of differentiating between different types of the instruction. In the example, pattern recognition layer 406 is capable of evaluating the arguments (e.g., features) of the instruction to determine whether the received input more closely resembles one prior received instruction or another. In recognizing whether an instruction resembles a prior received instruction, pattern recognition layer 406 can parse and tag extracted features (e.g., instructions and/or arguments) to identify features comprising words, terms, symbols, and/or syntax of ones previously input by the user. Those individual features sufficiently similar to ones previously received are passed to behavior check layer 408 to determine whether the features in aggregate correspond to a prior behavior.

FIG. 6C illustrates a comparison performed by behavior check layer 408. Behavior check layer 408 matches features corresponding to MKDIR1 with those of MKDIR2′. MKDIR2′ corresponds to behavior BHV2 of output layer 410. FIGS. 6C and 6D illustrate the operation of output layer 410. BHV2 corresponds to processor-executable actions 610, which are embedded in sequence 614. Output layer 410, in FIG. 6D, identifies sequence 614 as actions that based on initial user input 600, the user intends to replicate. Output layer 410 identifies sequence 614 to recommender 208, which outputs recommendation via user interface 202 that the user enable execution of the processor-executable actions embedded in sequence 614.

In certain embodiments, APGR framework 200 creates an execution stack for each behavior. An execution stack arranges the processor-executable actions corresponding to a prior behavior in a time-ordered sequence. Each entity acted upon by one or more of the processor-executable actions corresponding to a prior behavior can be arranged in an entity stack. An entity stack arranges discrete changes of the state of the entity in a time-ordered sequence.

Among the advantages of the stacks is the stacks help identify entity changes before and after execution of specific processor-executable actions. Behavior check layer 408 identifies a match when the processor-executable actions change one or more entities' state in the same manner (the pattern). APGR framework 200 can reference the entities' states as recorded in the stacks to determine which entities' states changed and how the states changed. If a user accepts an APGR framework 200 execution recommendation but then later decides to cancel the entity state changes, APGR framework 200 is able to roll back the changes as APGR framework 200 still has the previous states of the entities stored in the stacks.

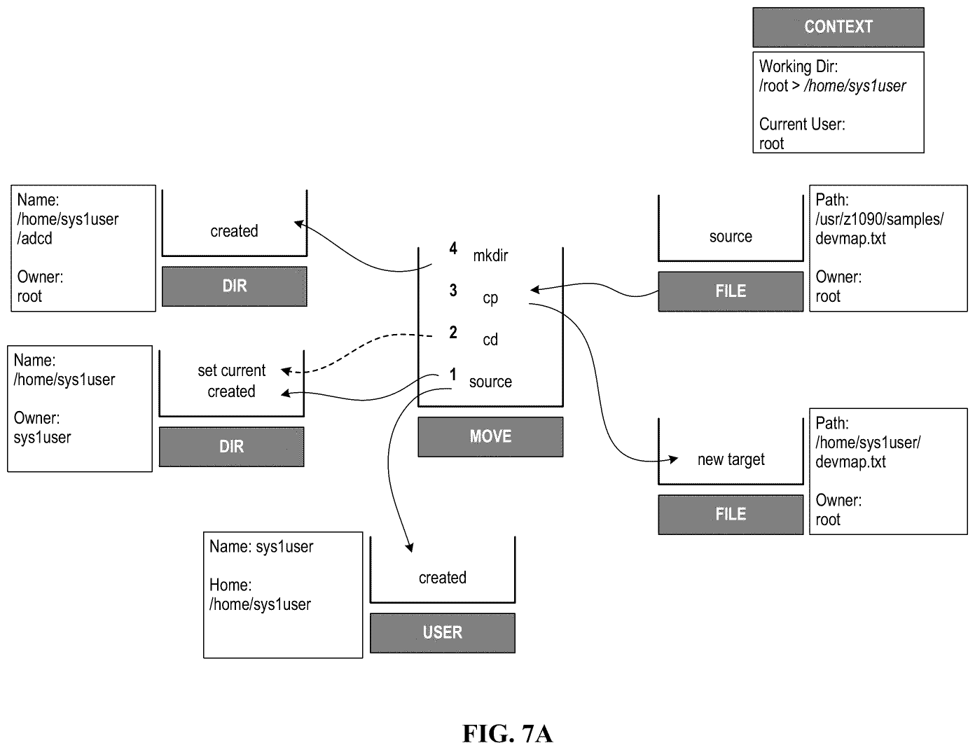

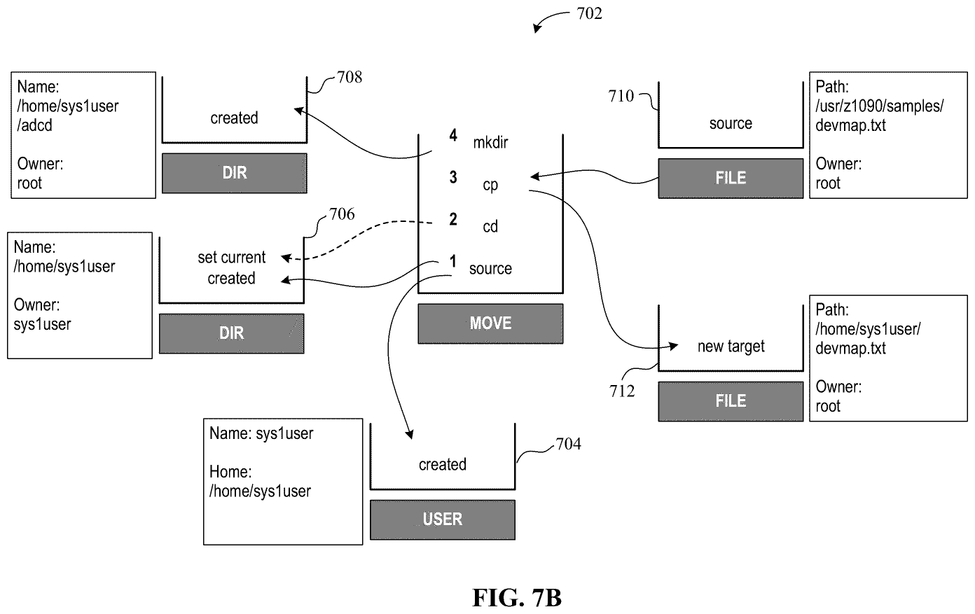

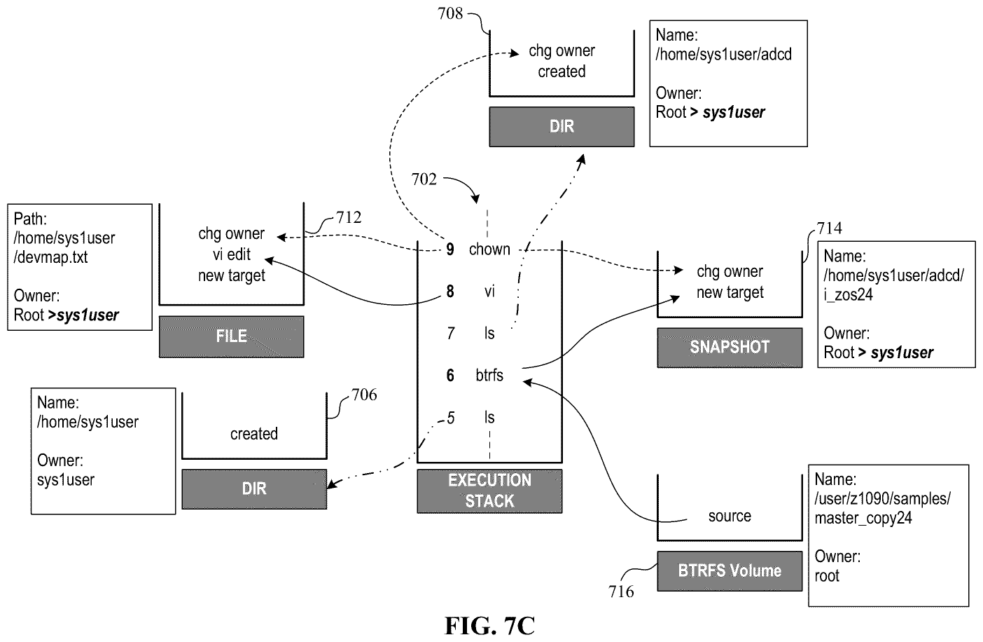

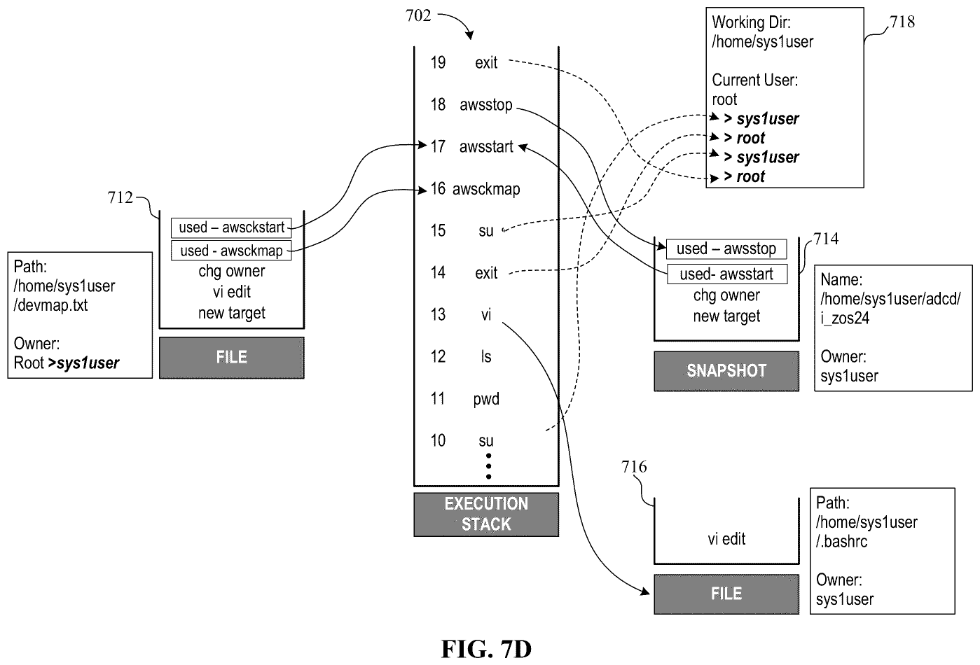

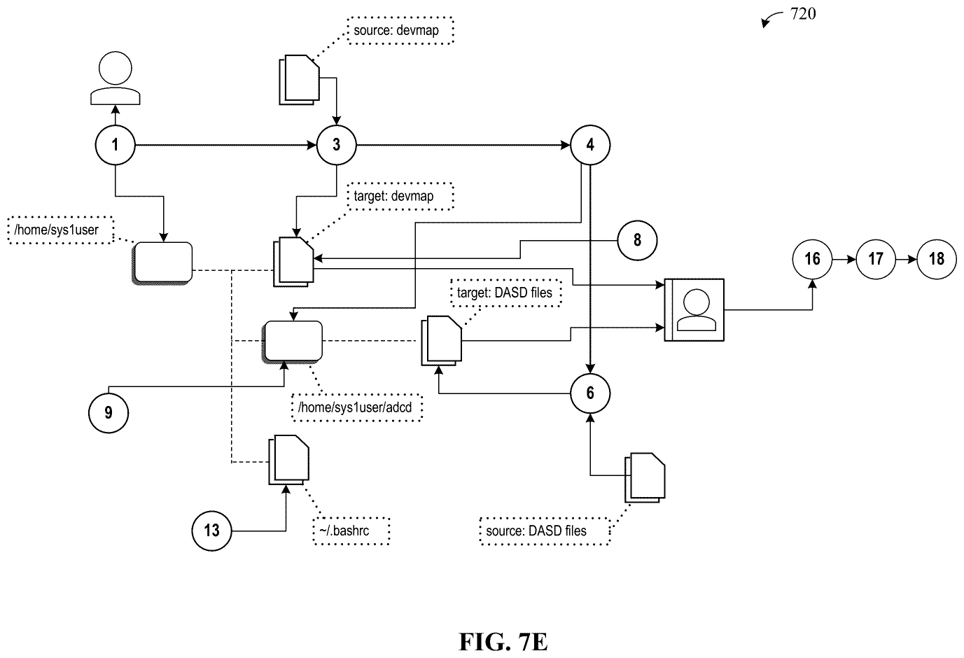

FIGS. 7A-7D illustrate an example application of the APGR framework 200 using an execution stack and multiple entity stacks. FIG. 7A illustrates multiple lines of code (computer language instructions) 700, which include Linux commands for creating a device map (DEVMAP) from a non-root user ID and a direct-access storage device (DASD) file. Code 700 corresponds to a behavior. APGR framework 200 builds an execution stack from code 700, each element of the stack corresponding to a line of code 700. APGR framework 200 creates an entity stack for each of the entities acted upon by the various commands of code 700. Each element of an entity stack corresponds to a change of state of the entity.

Illustratively, in FIG. 7B, execution stack 702 is built up from actions 1, 2, 3, and 4. Action 1 creates entity 704 and entity 706. Action 2 changes the state of entity 706. Action 3 creates entity 712 by copying entity 710. Entity 704 is created by command 4. In FIG. 7C, stack 702 increases with actions 5 through 9. Action 6 creates entity 714 from entity 716. Actions 8 and 9 sequentially change the state of entity 712. Action 9 also changes the state of entity 708. In FIG. 7D, execution stack 702 grows with the additions of actions 10 through 19. Entity 712 undergoes changes of state with actions 16 and 17. Entity 714 undergoes changes of state with action 17 and 18. The state of entity 716 changes in response to action 13. Actions10, 14, 15, and 19 generate contextual data. Contextual data indicates a behavior's context by indicating generic processing actions (e.g., “exit”) and entities (e.g., sysluser) to which the specific processing actions apply.

FIG. 7E schematically illustrates a replicable sequence of processor-executable actions 720 that APGR framework 200 is capable of creating for a behavior, the specific behavior corresponding to execution stack 702. Sequence of processor-executable actions 720 include actions 1, 3, 4, 6, 8, 9, 13, and 16-18. Actions 5, 7, 11, and 12 are deleted from the sequence as merely trivial actions in that the actions do not change the state of any entities. Actions 2, 10, 14, 15, and 19 provide only contextual data. Sequence of processor-executable actions 720 can automatically be executed if a user chooses to perform the same behavior. The user intent can be determined by APGR framework 200 based on extracting a subset of features from a user input. For example, the model of behavior predictor 204 can determine the user intent in response to extracting features that correspond to actions 1, 3, and 4. If the user chooses to enable execution of sequence of processor-executable actions 720, no further input is needed for invoking the remaining actions. APGR framework 200 can also enable the user to select different entities for actions 1, 3, 4, 6, 8, 9, 13, and 16-18 to act upon for creating a DEVMAP in accordance with the identified behavior.

In another example, a user working at a Linux terminal, for example, may enter the following commands for execution by a computer processor:
1. Login as root;
2. Create a new ID as USER1: useradd user1;
3. Create a folder in USER1's home: mkdir/user1/testcase;
4. Copy source data to the folder: cp-R/opt/testcase/*/home/user1/testcase/;
5. Change the owner of the data copied: chown-R user1:user1/home/user1;
6. Update access to the data copied: chmod-R 700 home/user1/testcase/*
   Illustratively, the user may then repeat entering these commands to the computer:
7. Create a new ID as USER2: useradd user2;
8. Create a folder in USER2's home: mkdir/user2/testcase;
9. Copy source data to the created folder: cp-R/opt/testcase/*/home/user2/testcase/;
10. Change the owner of the data copied: chown-R user2:user2/home/user2;
11. Update access to the data copied: chmod-R 700 home/user2/testcase/*.

APGR framework 200 based on the repetition of commands entered by the user is able to create a behavior. The behavior is determined by APGR framework 200 based on the repetition of commands. That is, commands 7 through 11 repeat prior commands 2 through 6. APGR framework 200 can generate an execution stack corresponding to the behavior (which can be added to prior behaviors), the execution stack comprising the repeated commands. For the instant example, the execution stack illustratively comprises code for replicating the behavior with the following processor-executable commands:
Action 1: USERADD
Action 2: MKDIR
Action 3: CP
Action 4: CHOWN
Action 5: CHMOD

The first action creates a new ID. The second action creates a director in the new ID's home. The third, fourth, and fifth actions replicate the behavior with respect to the new ID. Accordingly, the behavior is replicated for an entity identified in the commands by userid corresponding to actions 1 through 5:
Action 1: <userid>
Action 2:/home/<userid>/testcase/*
Action 3:/home/<userid>/testcase/*
Action 4: <userid>:<userid> and/home/<userid>
Action 5:/home/<userid>/testcase/*

With respect to each of the actions, APGR framework 200 is capable of predicting an entity based on the ID corresponding to userid. Illustratively, if (e.g., within a predetermined time interval) the user enters the following commands to execute processor actions:
Create a new ID as USER3: useradd user3; and
Create a folder in in USER3's home: mkdir/user3testcase;
   then APGR framework 200 is capable of predicting three subsequent actions:
Copy source data to the folder: cp-R/opt/testcase/*/home/<userid>/testcase/;
Change the owner of the copied data: chown-R<userid>:<userid>/home/<userid>;
Update access to the data copied: chmod-R 700 home/<userid>/testcase/*.

If user3 is “Mike” in the initial action of create an ID, for example, then APGR framework 200 predicts that the subsequent actions are to be replicated with respect to the entity identified by the userid Mike. APGR framework 200 can treat userid as a variable. The value of the variable (userid) is used by APGR framework 200 to determine the entity for which the subsequent replicated actions are executed.

When a user, within a predetermined time interval, enters the same initial command(s) as previously entered and that correspond to a prior behavior, APGR framework 200 is capable of replicating the subsequent processor-executable actions of the prior behavior. APGR framework 200 can output a recommendation that the user enable automatic execution of the sequence of processor-executable actions, thus saving the user from having to enter the same sequence of commands.

The processor-executable actions can be executed with respect to one or more entities predicted by APGR framework 200. The prediction can be made by identifying an entity or entities specified in the initial command(s), where the command(s) includes a term (e.g., userid) that APGR framework 200 processes as a variable. The value of the variable is applied by APGR framework 200 in the execution of the subsequent processor-executable commands of the prior behavior. In other embodiments, additionally or alternatively, APGR framework 200 prior to executing the prior behavior can output a user query requesting user input specifying one or more entities to which the replicated processor-executable actions are to be applied.

Optionally, prior to execution, the processor-executable actions can be provided to the user (e.g., via a GUI) as a viewable list, for example. APGR framework 200 can enable the user to input a modification to one or more of the processor-executable actions prior to execution of the remaining actions that comprise the prior behavior. This enables the user to repeat a prior behavior, though modified to some extent in response to changed conditions or circumstances.

In the event that the processor-executable actions of a behavior include multiple branches, APGR framework 200 can enable the user's selecting which branch to go to. For example, if the behavior includes an action sequence from A to B, and from B to either C or D, then APGR framework 200 presents the action sequence A→B→ (C or D) and enables the user's choosing to branch to C or D.

The terminology used herein is for the purpose of describing particular embodiments only and is not intended to be limiting. Notwithstanding, several definitions that apply throughout this document now will be presented.

The term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or,” are open-ended expressions that are both conjunctive and disjunctive in operation unless explicitly stated otherwise. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without user intervention.

As defined herein, the terms “includes,” “including,” “comprises,” and/or “comprising,” specify the presence of stated features, integers, steps, operations, elements, and/or components, but do not preclude the presence or addition of one or more other features, integers, steps, operations, elements, components, and/or groups thereof.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “output” means storing in physical memory elements, e.g., devices, writing to display or other peripheral output device, sending or transmitting to another system, exporting, or the like.

As defined herein, the term “processor” means at least one hardware circuit configured to carry out instructions. The instructions may be contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “real time” means a level of processing responsiveness that a user or system senses as sufficiently immediate for a particular process or determination to be made, or that enables the processor to keep up with some external process.

As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

As defined herein, the term “user” refers to a human being.

The terms first, second, etc. may be used herein to describe various elements. These elements should not be limited by these terms, as these terms are only used to distinguish one element from another unless stated otherwise or the context clearly indicates otherwise.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
extracting, by a processor of a computer in real time, features from user input to the computer;
comparing, by the processor, the features extracted with recorded features corresponding to a prior behavior;
predicting, by the processor, user-intended action in response to a match between the features extracted and the features corresponding to the prior behavior; and
generating, by the processor, a sequence of processor-executable actions corresponding to the prior behavior.

2. The method of claim 1, wherein the method further comprises:
outputting a recommendation that the user enable automatic execution of the sequence of processor-executable actions; and
executing the sequence of processor-executable actions in response to the user enabling the automatic execution.

3. The method of claim 2, wherein the method further comprises:
modifying the sequence of processor-executable actions based on a user response to the recommendation prior to the executing.

4. The method of claim 2, wherein the recommendation is output in real-time on a graphical user interface of the computer.

5. The method of claim 1, wherein the predicting is in response to determining that the prior behavior was executed within a user-specified relevant time interval.

6. The method of claim 1, wherein the prior behavior corresponds to an execution stack configured to arrange the sequence of processor-executable actions corresponding to the prior behavior in a time-ordered sequence.

7. The method of claim 1, wherein each entity acted upon by the sequence of processor-executable actions corresponding to the prior behavior is represented by an entity stack configured to arrange state changes of an entity in a time-ordered sequence.

8. The method of claim 1, wherein the method further comprises:
predicting one or more entities acted upon by the sequence of processor-executable actions.

9. The method of claim 1, wherein the method further comprises:
validating the user input to exclude an invalid feature.

10. The method of claim 1, wherein the method further comprises:
generating a new behavior in response to determining that the features extracted do not match features corresponding to the prior behavior, wherein the new behavior includes the features extracted and one or more follow-on features executed in response to additional user input.

11. A system, comprising:
one or more processors configured to initiate operations including:
extracting, in real time, features from user input to the system;
comparing the features extracted with recorded features corresponding to a prior behavior;
predicting user-intended action in response to a match between the features extracted and the features corresponding to the prior behavior; and
generating a sequence of processor-executable actions corresponding to the prior behavior.

12. The system of claim 11, wherein the one or more processors are configured to initiate operations further including:
outputting a recommendation that the user enable automatic execution of the sequence of processor-executable actions; and
executing the sequence of processor-executable actions in response to the user enabling the automatic execution.

13. The system of claim 12, wherein the one or more processors are configured to initiate operations further including:
modifying the sequence of processor-executable actions based on a user response to the recommendation prior to the executing.

14. The system of claim 11, wherein the predicting is in response to determining that the prior behavior was executed within a user-specified relevant time interval.

15. The system of claim 11, wherein the prior behavior corresponds to an execution stack configured to arrange the sequence of processor-executable actions corresponding to the prior behavior in a time-ordered sequence.

16. The system of claim 11, wherein each entity acted upon by the sequence of processor-executable actions corresponding to the prior behavior is represented by an entity stack configured to arrange state changes of an entity in a time-ordered sequence.

17. The system of claim 11, wherein the one or more processors are configured to initiate operations further including:
predicting one or more entities acted upon by the sequence of processor-executable actions.

18. The system of claim 11, wherein the one or more processors are configured to initiate operations further including:
generating a new behavior in response to determining that the features extracted do not match features corresponding to the prior behavior, wherein the new behavior includes the features extracted and one or more follow-on features executed in response to additional user input.

19. A computer program product, the computer program product comprising:
one or more computer-readable storage media and program instructions collectively stored on the one or more computer-readable storage media, the program instructions executable by a processor to cause the processor to initiate operations including:
extracting, in real time, features from a user input;
comparing the features extracted with recorded features corresponding to a prior behavior;
predicting user-intended action in response to a match between the features extracted and the features corresponding to the prior behavior; and
generating a sequence of processor-executable actions corresponding to the prior behavior.

20. The computer program product of claim 19, wherein the program instructions are executable by the processor to cause the processor to initiate operations further including:
outputting a recommendation that the user enable automatic execution of the sequence of processor-executable actions; and
executing the sequence of processor-executable actions in response to the user enabling the automatic execution.
